(19) United States
(12) Patent Application Publication
(10) Pub. No.: US 2012/0115673 A1
(43) Pub. Date: May 10, 2012

(54) OUTPUT SHAFT ENDPLAY ADJUSTMENT METHOD FOR 700R4/4L60E FAMILY

(76) Inventor: Luther Preston Deans, Clayton, NC (US)

(21) Appl. No.: 13/288,008

(22) Filed: Nov. 2, 2011

Related U.S. Application Data
(60) Provisional application No. 61/409,231, filed on Nov. 2, 2010.

(51) Int. Cl. F16H 57/08; F16C 3/02; B23P 6/00

(52) U.S. Cl. 475/331; 29/402.09; 464/179

(57) ABSTRACT

The objective of the invention is to provide a fast way to adjust endplay on output shaft without removing entire output shaft gear train assembly. One embodiment of the present invention is to place the shims in new location between the outer most ring gear hub and the ring gear stop on the output shaft. The new shims will have spines so they can be placed between the output stop and the ring rear hub. Another embodiment of the present invention, a preferred method to adjust endplay is to use a @ Torrington thrust bearing between the transmission case and output shaft. This will prevent reoccurring endplay adjustments from wear.

### REFERENCE TO RELATED APPLICATIONS

This patent application claims the benefit of U.S. Provisional Application No. 61/409,231 filed on Nov. 2, 2010 the disclosure of which is incorporated herein by reference in its entirety.

### BACKGROUND OF THE INVENTION

1. Field of the Invention

The present invention relates generally to automatic transmissions, and more specifically to output shaft endplay adjustment method for GM automatic transmission 700r4/4l60e family.

2. Description of Related Art

Since GM first introduced the four speed automatic overdrive in the Corvette in 1982, the 700R4/4L60E family had many failures. It is understood that any reference hereinafter to the 4L60E/700R4 transmissions includes the 700R4/4L60E family from 1982 to present. The factory made improvements every year along with the aftermarket transmission improvement industry. But there are still a few problems remaining to be overcome. One of a few remaining failures is related to the excessive output shaft endplay occurred in GM 700r4/4l60e automatic transmission from 1982 to present.

The output shaft carries the drive train assembly this is called after assembly the “output shaft stack-up height”. The output drive train assembly wears quickly due to the output shaft placing thrust forces into the entire drive train all the way from rear thru to the front of the transmission. As the drive train wears the “drive train stack height” shortens from wear. As the stack height shortens the output shaft endplay increases.

If the output shaft endplay is excessive the shaft can contact the input shaft & restrict oil flow to the output shaft gear train causing failure. Excess endplay also causes ramming forces that can send damage thru out the transmission. On the 700r4 the excess endplay causes erratic shifting from the governor.

The factory has no published endplay adjustment for the output shaft endplay. During overhaul a method in needed to properly adjust output endplay. To make adjustments requires removing the entire output shaft gear train assembly to place a shim behind the ring gear. This existing repair procedure increases assembly time, making adjustments time consuming.

Even though the new factory transmission has the endplay preset between the rear planetary hub & the raised stop at the orifice. As the rear differential moves vertically over varying road surfaces the vertical motion changes to horizontal motion in the drive shaft. Thrust is transferred into the rear output shaft from the drive shaft. The thrust forces pass thru the [stack-up] gear train, then into the input drum, into the stator housing, into the front pump ending into the case. These causes wear throughout the transmission. On the output shaft this wear decreases the [stack-up] height; this in turn causes excess output shaft endplay.

There is no invention in the prior art that addresses these problems. Therefore, there exists a need to have an invention that provides a simple, easy, and time saving method/device to adjust the output shaft endplay for GM 700r4/4l60e family automatic transmission.

### SUMMARY OF THE INVENTION

One object of the invention is to provide a simple, easy, and time saving method to adjust the output shaft endplay for GM 700r4/4l60e family automatic transmission.

A further object of the invention is to provide a method to adjust output shaft endplay without removing the entire output shaft gear train assembly.

Yet a further object of the invention is to provide a method which does not require disassembly of the stack-up, thus is time saving.

Yet a further object of the invention is to provide a method that can control thrust and prevent reoccurring endplay adjustments from wear.

One embodiment of adjusting the output shaft endplay without thrust control according to the present invention comprises placing special shims and a snap ring between the end of the rear planetary ring gear hub and the output shaft outer most oiling orifice which is the ring gear hub stop. This method does not require removing entire output shaft gear train assembly or disassembling the stack-up, and thus is more efficient than the existing repair method. This method can be used on all 700R4-4L60E-4L70-present. The shims & snap ring are placed on the output shaft between the output stop & the ring rear hub.

One embodiment of adjusting the output shaft endplay with thrust control according to the present invention comprises placing @Torrington bearing between the transmission case and the output shaft. The preferred method is using the @Torrington bearing for easy adjustment with no thrust loads placed inside the transmission. For the 700r 1982 thru 1993, the method requires a thrust plate, @Torrington bearing, split shaft collar. For the 1993 to present needs only @Torrington bearing, split collar, shims.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a flow chart of the procedure according to a first embodiment of the present invention. This embodiment has no thrust control all years.

FIG. 2 shows a partial transmission after assembled by the first embodiment.

FIG. 3 illustrates the flow chart of the procedure according to a second embodiment of the present invention which is designed for 700r4 automatic transmission with thrust control.

FIG. 4, shows a flow chart of the procedure according to a third embodiment of the present invention.

FIG. 5 shows a partial transmission after assembled by the second and/or third embodiment.

### DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

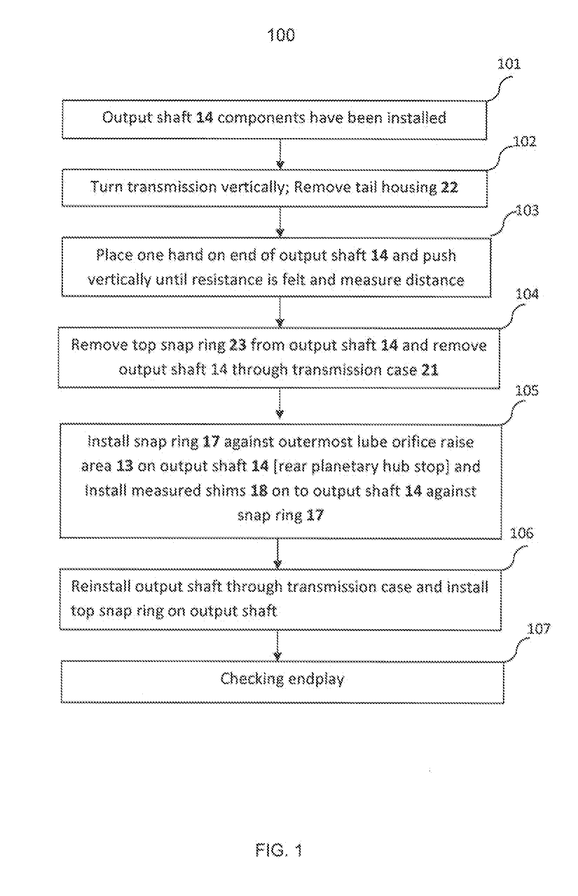

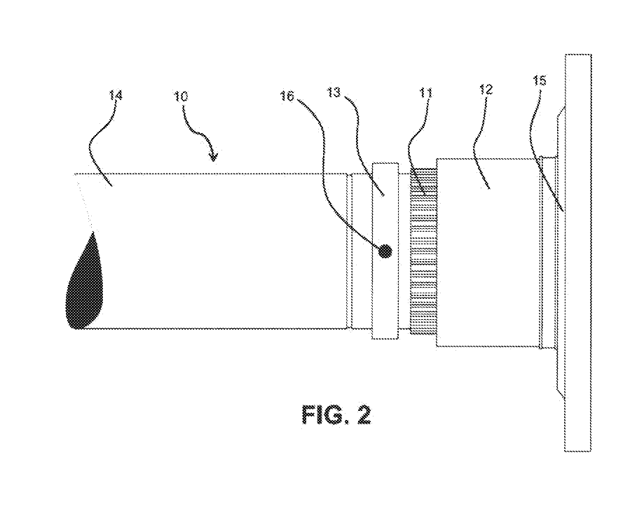

Referring to FIG. 1, there is disclosed a flow chart of the procedure according to a first embodiment of the present invention. This embodiment can be applied to GM 704r/4l60e family but has no thrust control all years. The method comprises steps of installing output shaft components; turning transmission vertically, removing the tail housing which supports transmission case so output shaft hangs freely; placing hand on end of output shaft and pushing vertically until resistance is felt; measuring the distance that the output shaft has moved; removing the top snap ring from the output shaft and removing output shaft thru the bottom of case; installing snap ring against outermost lube orifice raise area on the output shaft [rear planetary hub stop]; installing measured shims, less 0.010 to 0.020 thousands clearance on to output shaft against snap ring; reinstalling output shaft thru bottom of case and installing top snap ring on output shaft; and checking endplay.

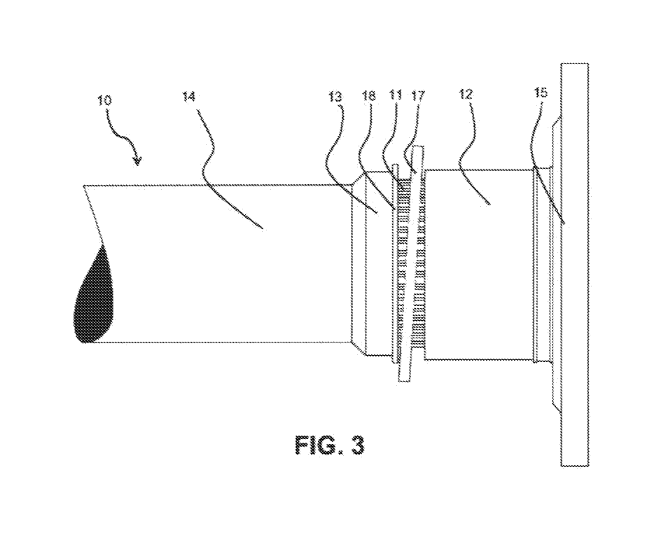

Partial of the transmission before and after assembling using the first embodiment is illustrated in FIG. 2 and FIG. 3 respectively which show an output shaft 14 and the outermost lube orifice 13 on the output shaft 14. This outermost lube orifice 13 is raised to stop the rear planetary hub 15. Near the front of the output shaft 14 a snap ring 17 holds the front planetary gear carrier. Between the front planetary carrier snap ring & the rear planetary hub is the output shaft [stack-up], which has all components that make up the output shaft drive train. The end of the output shaft shows the spines 11 that the rear differential drive shaft slides on. The invention places shims 18 and snap ring retainer 19 (not shown) to adjust the endplay between the rear planetary hub 15 and raised stop at the lube orifice 13.

The preferred method to adjust endplay is to use a @ Torrington thrust bearing between the transmission case and output shaft. This will prevent reoccurring endplay adjustments from wear.

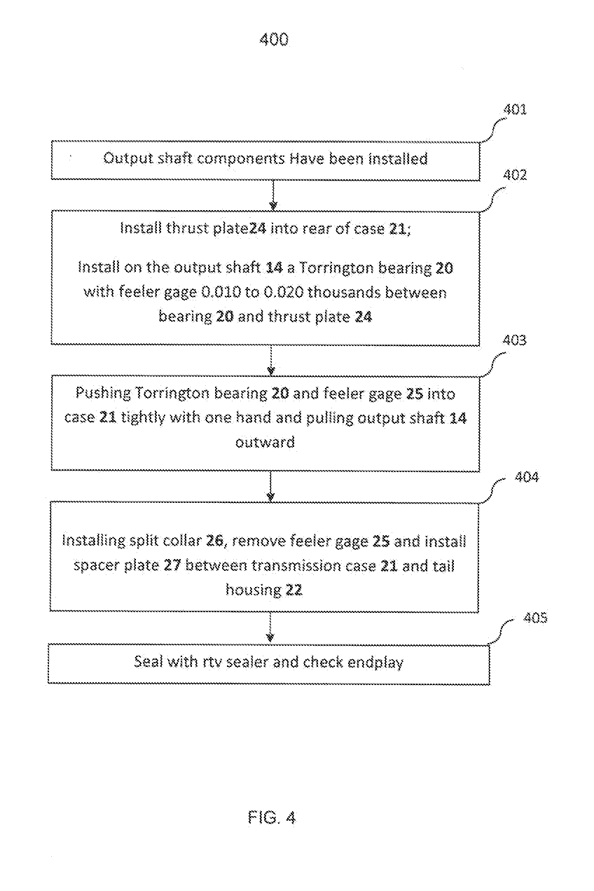

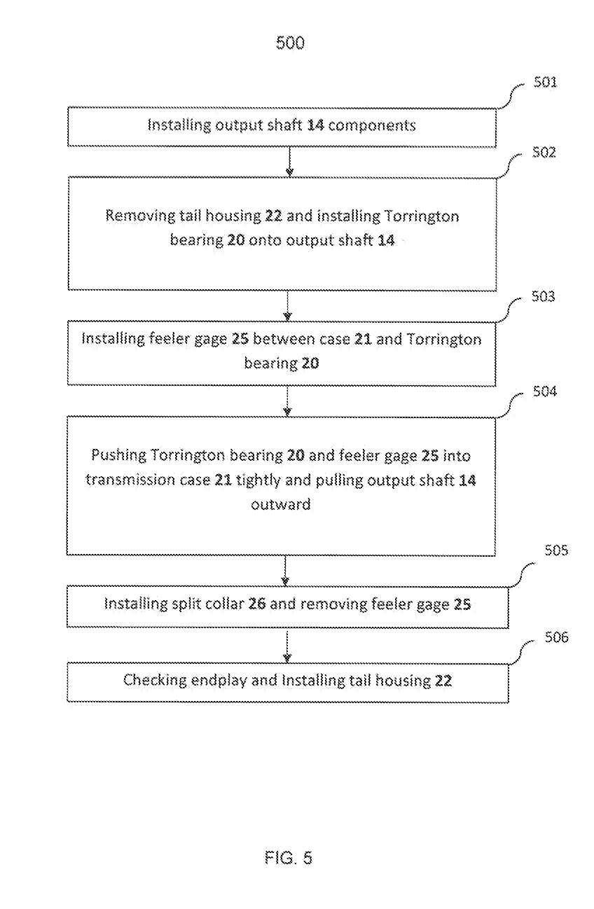

FIG. 4 illustrates the flow chart of the procedure according to a second embodiment of the present invention which is designed for 700r4 automatic transmission with thrust control. The components/parts required for the second embodiment of method to be implemented are a thrust plate, @Torrington bearing, split collar, shims, and spacer plate.

The embodiment comprises: installing output shaft components with output shaft, installing thrust plate into rear of case, then installing on the output shaft the @Torrington bearing with feeler gage 0.010 to 0.020 thousands between bearing and thrust plate; pushing Torrington bearing and feeler gage into case tightly with one hand and pulling output shaft outward; installing split collar; removing feeler gage; installing spacer plate between case and tail housing; sealing with rtv sealer; and checking endplay.

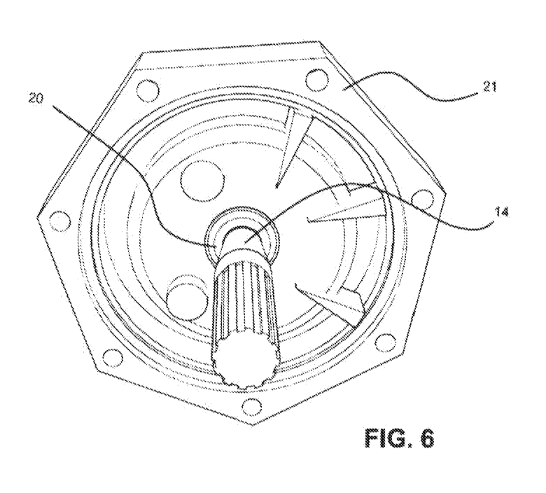

Referring to FIG. 5, there is disclosed a flow chart of the procedure according to a third embodiment of the present invention. The third embodiment of the method is designed for 4l60e automatic transmission through present with thrust control. The method comprises steps of installing output shaft components; removing tail housing and installing @Torrington bearing onto output shaft; installing feeler gage 0.010 to 0.020 between case and @Torrington bearing; pushing the @Torrington bearing and feeler gage into case tightly and pulling output shaft outward; installing split collar; removing feeler gage; checking endplay; and. installing tail housing.

Partial of the transmission after assembled by the second and/or third embodiment is illustrated in FIG. 6 where the Torrington bearing 20 is installed between the transmission case 21 and the output shaft 14.

To make the invention manufacture steel washers to go over the output shaft to be placed against the output shaft ring gear thrust stop.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of adjusting the output shaft endplay for GM automatic transmission comprising placing special shims between the end of the rear planetary ring gear hub and the rear planetary ring gear hub stop on the output shaft.

2. A method of adjusting the output shaft endplay for GM automatic transmission comprising placing a Torrington thrust bearing between the transmission case and output shaft for thrust control.

3. The method of adjusting the output shaft endplay for GM automatic transmission of claim 1 further comprising: installing snap ring against outer most lube orifice raise area on the output shaft which is the rear planetary hub stop.

4. The method of adjusting the output shaft endplay for GM automatic transmission of claim 3 wherein the shims is installed on to output shaft against the snap ring.

5. The method of adjusting the output shaft endplay for GM automatic transmission of claim 4 wherein the installed shims is measured less 0.010 to 0.020 thousands clearance on to output shaft against snap ring.

6. The method of adjusting the output shaft endplay for GM automatic transmission of claim 4 wherein the special shims.

7. The method of adjusting the output shaft endplay for GM automatic transmission of claim 2 further comprising installing thrust plate into rear of case.

8. The method of adjusting the output shaft endplay for GM automatic transmission of claim 7 wherein the @Torrington bearing is installed with feeler gauge 0.010 to 0.020 thousands between the bearing and the thrust plate.

9. The method of adjusting the output shaft endplay for GM automatic transmission of claim 8 further comprising pushing the thrust plate and the bearing into the case tightly with one hand and pulling output shaft outward; and installing split collar; removing feeler gauge; installing spacer plate between case and tail housing.

10. The method of adjusting the output shaft endplay for GM automatic transmission of claim 2 wherein Torrington bearing is installed onto output shaft.

11. The method of adjusting the output shaft endplay for GM automatic transmission of claim 10 further comprising installing a feeler gauge 0.010 to 0.020 between the case and the Torrington bearing; pushing the bearing and the feeler gage into the case tightly and pulling the output shaft outward; installing split collar; and removing the feeler gage.

12. A transmission with improved output shaft endplay comprising placing additional parts on to the output shaft in a new location.

13. The transmission with improved output shaft endplay of claim 12, wherein the additional parts being shim & snap ring placed between the end of the rear planetary ring gear hub and the rear planetary ring gear hub stop on the output shaft.

14. The transmission with improved output shaft endplay of claim 12, wherein the additional parts being a Torrington bearing placed between a transmission case and the output shaft with a split collar.
